(19) United States
(12) Patent Application Publication
(10) Pub. No.: US 2025/0117829 A1
(43) Pub. Date: Apr. 10, 2025

(54) BRAND-ALIGNED MARKETING CONTENT GENERATION USING STRUCTURED BRAND DATA AND GENERATIVE MODELS

(71) Applicant: ADOBE INC., San Jose, CA (US)

(72) Inventors: Mayank ANAND, Fremont, CA (US); Jose MATHEW, San Jose, CA (US); Divyanshu GOYAL, Sunnyvale, CA (US)

(21) Appl. No.: 18/377,550

(22) Filed: Oct. 6, 2023

(51) Int. Cl. G06Q 30/0241; G06F 40/40; G06Q 30/0201

(52) U.S. Cl. CPC G06Q 30/0276; G06F 40/40; G06Q 30/0201

(57) ABSTRACT

Systems and methods employ generative models to generate structured brand data and/or brand-aligned marketing content. In accordance with some aspects, brand source data for an entity is accessed. A first generative model generates structured brand data using the brand source data, wherein the structured brand data is generated to include a number of components. The first generative model or a second generative model generates brand-aligned marketing content using the structured brand data. Alignment scores are determined for the brand-aligned marketing content. Each alignment score corresponds to a component of the structured brand data. The brand-aligned marketing content and at least a portion of the alignment scores are provided for presentation.

### BACKGROUND

In the current digital world, entities often strive to generate and use content to reflect their brands by carefully crafting messaging and visuals that align with their brand identity and values. However, creating such brand-aligned content is a complex task, requiring deep understanding of the brand's guidelines and creative application across various platforms and contexts. This process typically requires a comprehensive understanding of the target audience and market trends, allowing entities to tailor their content to resonate with their desired customer base. Brand guidelines, including tone of voice, color schemes, and logos, serve as a foundation for content creation, ensuring consistency across various channels. Whether through social media, websites, advertisements, or blog posts, entities aim to convey a cohesive brand narrative that evokes emotions, builds trust, and establishes a unique brand personality. By maintaining this consistency and authenticity in their marketing content, entities can effectively communicate their brand's story, values, and promises to connect with their audiences on a deeper level, ultimately driving brand loyalty and growth.

### SUMMARY

Some aspects of the present technology relate to, among other things, a content generation system that employs generative models to generate structured brand data and brand-aligned marketing content. In accordance with some aspects, the content generation system accesses brand source data that exhibit aspects of an entity's brand in an unstructured way. The brand source data is provided as input to a generative model, which generates structured brand data that organizes brand information into components according to a specific schema. The content generation system also generates a confidence score for each component of the structured brand data to provide an indication of the extent to which each component of the structured brand data comports to the brand aspects exhibited by the brand source data.

In further aspects, the content generation system employs structured brand data to generate brand-aligned marketing content. The structured brand data is provided as input to a generative model, which generates brand-aligned marketing content in accordance with brand aspects set forth in the structured brand data. The content generation system also generates alignment scores for the brand-aligned marketing content. Each alignment score provides an indication of the extent to which the brand-aligned marketing content comports to the structured brand data.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram illustrating generation of structured brand data from brand source data in accordance with some implementations of the present disclosure;

FIG. 3 provides an example of structured brand data generated from brand source data in accordance with some implementations of the present disclosure;

FIG. 4 is a block diagram illustrating using brand source content as a premise and a structured brand data component as a hypothesis for determining a confidence score for the structured brand data component in accordance with some implementations of the present disclosure;

FIG. 5 is an example user interface presenting a component of structured brand content generated using a generative model and its associated confidence score in accordance with some implementations of the present disclosure;

FIG. 6 is a block diagram illustrating generation of brand-aligned marketing content using structured brand data in accordance with some implementations of the present disclosure;

FIG. 7 is a block diagram illustrating using marketing as a premise and a structured brand data component as a hypothesis for determining a confidence score for the brand-aligned marketing content with respect to the structured brand data component in accordance with some implementations of the present disclosure;

FIG. 8 is a flow diagram showing a method for generating structured brand data from brand source data in accordance with some implementations of the present disclosure;

FIG. 9 is a flow diagram showing a method for generating a confidence score for a structured brand data component in accordance with some implementations of the present disclosure;

FIG. 10 is a flow diagram showing a method for generating brand-aligned marketing content using structured brand data in accordance with some implementations of the present disclosure;

FIG. 11 is a flow diagram showing a method for generating a confidence score for brand-aligned marketing content with respect to a structured brand data component in accordance with some implementations of the present disclosure; and

FIG. 12 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, “brand source data” refers to information describing, exhibiting, or otherwise related to or evident of an entity's brand. Brand source data can include materials, documents, and/or multimedia content that communicate information regarding an entity, such as its identity, values, and messaging. By way of example only and not limitation, brand source data can include an entity's website, social media profile, advertising/marketing materials, taglines, slogans, logos, mission statements, vision statements, product packaging, and brand guideline documents. In accordance with some aspects of the technology described herein, brand source data comprises unstructured data in the sense that the data does not conform to a particular schema. For instance, while some brand source data may have some internal organization (e.g., organized into different sections), the various brand source data for the different entities does not conform to a common schema.

As used herein, “structured brand data” (sometimes also referred to as “brand DNA”) refers to information describing the concepts and characteristics that define an entity's brand. In accordance with some aspects of the technology described herein, the structured brand data is structured according to a particular schema having a number of “components.” For instance, in accordance with some aspects, a schema for structured brand data could include the following components: tone of voice, brand values and attributes, brand imaging and messaging, taglines, forbidden taglines, brand keywords, forbidden keywords, and extra information. In some aspects, the structured brand data can be stored in a particular format, such as a JSON format.

As used herein, “marketing content” comprises the various types of materials and information created and used by an entity to promote its products, services, brand, and/or ideas to its target audience. Marketing content can take many forms and be distributed through various channels. By way of example only and not limitation, marketing content can include blog posts, social media posts, email marketing, webpages, press releases, advertisements, interactive content, infographics, and whitepapers. In accordance with some aspects described herein, “brand-aligned marketing content” refers to marketing content that comports to an entity's brand, for instance, as exhibited by structured brand data.

A “generative model” is used herein in the context of natural language processing to refer to a type of machine learning model that generates new text. In accordance with some aspects of the technology described herein, a generative model generates structured brand data given brand source data. In accordance with some aspects of the technology described herein, a generative model generates brand-aligned marketing content given structured brand data. In some configurations, a generative model comprises a large language model (LLM) that is designed to understand and generate human-like text. An LLM generally refers to a type of generative model that has been trained on massive amounts of text data to learn the patterns, relationships, and semantics of language. By way of example only and not limitation, various configurations can employ an LLM built from scratch, a pre-trained LLM (e.g., GPT-3), or a pre-trained LLM that has been fine-tuned.

As used herein, a “confidence score” refers to a score (numerical or text) that reflects a confidence that structured brand data generated by a generative model accurately captures brand information from brand source data. A confidence score can be determined for each component of the structured brand data that reflects an extent to which each component comports to one or more portions of the brand source data used to generate the structured brand data.

A “latent vector space” (or “embedding space”) is a mathematical representation where items are transformed by a model into numerical vectors. A vector representation of an item in a latent vector space of a model is referred to herein as an “embedding.” A latent vector space enables a measurement of similarity between items based on the geometric properties of their embeddings in the latent vector space. Similar items tend to have embeddings that are close in proximity in the latent vector space, as they share similar characteristics or context.

An “alignment score” refers to a score (numerical or text) that reflects alignment of brand-aligned marketing content generated by a generative model with structured brand data. An alignment score can be determined for each component of the structured brand data used to generated the brand-aligned marketing content with each alignment score providing an indication as to an extent to which the brand-aligned marketing content comports to each component of the structured brand data.

### Overview

Brand DNA is a concept used in marketing to describe the fundamental and unique characteristics that make up the identity and personality of an entity's brand. Brand DNA serves as a brand's digital fingerprint, enabling unique identification and differentiation in the marketplace. However, crucial brand DNA elements for an entity are frequently scattered across unstructured formats such as PDFs or websites. The absence of structure presents challenges in extracting, comprehending, and implementing the brand DNA elements consistently in the entity's marketing content. Manual conversion of this unstructured data into a structured format is not only labor-intensive and error-prone but also fails to capture the intricacies of a brand's distinct digital fingerprint adequately.

Current marketing content creation strategies for entities largely rely on manual efforts, with creators interpreting aspects of the entity's brand DNA to produce brand-representative content. Content creators, marketers, and copywriters require a comprehensive understanding and interpretation of brand guidelines, making sure the content they create embodies the brand's unique identity, voice, and messaging. However, this approach is not only time-consuming and labor-intensive but also suffers from inconsistency due to the inherent subjectivity of individual creators' interpretations of the guidelines.

There have been attempts to automate the content generation process using various technologies such as Natural Language Processing (NLP) and Machine Learning (ML). However, these solutions often fall short in producing truly brand-aware content in a consistent manner. While they are capable of generating grammatically correct and contextually relevant content, they often fail to incorporate the nuances of a brand's unique identity, resulting in generic and impersonal content.

Existing methods often employ rudimentary techniques such as sentiment analysis and keyword density to ensure alignment with the brand's guidelines. While sentiment analysis may capture the general emotional tone of a brand, it lacks the finesse to fully represent the entity's brand DNA, which involves a broader spectrum of elements including unique attributes, messaging guidelines, and specific taglines. Similarly, maintaining keyword density can ensure the frequent appearance of brand-related terms but does not guarantee the correct context or intended message.

Furthermore, existing solutions lack a robust mechanism to validate the authenticity of the generated content against the brand's guidelines. As a result, there is no way to ascertain if the content truly adheres to the brand's voice, tone, and values. This missing component increases the risk of brand dilution and misrepresentation, which can undermine a brand's reputation and standing in the competitive market.

Moreover, unnecessary computing resources are utilized in the generation of content using conventional approaches. For example, computing and network resources are unnecessarily consumed to facilitate the labor-intensive process in reviewing and revising both manually-generated and automatically-generated content. For instance, computer input/output operations are unnecessarily increased in the process of manually generating content when a review and revision process is used to ensure the generated content complies with brand guidelines. Automated solutions similarly lack the ability to ensure that the generated content comports with brand guidelines. As such, computer input/output operations are unnecessarily increased in the process of reviewing and revising the automatically-generated content. Further, when generated content is located in a disk array, there is unnecessary wear placed on the read/write head of the disk of the disk array each time the content is accessed, for instance, to review and/or revise the content. Even further, the review and revision process decreases the throughput for a network, increases the network latency, and increases packet generation costs when the information is located over a network.

Aspects of the technology described herein improve the functioning of the computer itself by providing a content generation system that addresses the limitations of current solutions. Among other things, the content generation system transforms information regarding an entity's brand from an unstructured state to a structured state. In particular, the content generation system accesses brand source data for an entity. The brand source data comprises information exhibiting the entity's brand in an unstructured state. The content generation system provides the brand source data to a generative model, which generates structured brand data having components (e.g., tone of voice, brand value and attributes, brand imaging and messaging, taglines, keywords, etc.) according to a specific schema. In particular, the generative model generates text describing aspects of each component based on the brand source data. In some aspects, the brand source data is provided as part of a prompt that is input to the generative model, where the prompt provides information that instructs the generative model on the generation of the structured brand data (e.g., specifying the components of the structure brand data to generate).

The content generation system also determines a confidence score for each component of the structured brand data. Each confidence score provides an indication of the extent to which each component comports to brand aspects exhibited by the brand source data. In this way, the content generation system provides a mechanism for verifying the structured brand data provided by the generative model accurately captures the concepts and characteristics of the entity's brand as set forth in the brand source data. In some aspects, the confidence score for a given component of the structured brand data is generated by comparing the component against a portion of the brand source data relevant to the component, for instance, using a Natural Language Inference (NLI) paradigm in which the portion of the brand source data is treated as a premise and the component of the structured brand data is treated as a hypothesis. In some aspects, a latent vector embedding approach is employed to identify portions of the brand source data relevant to each component of the structured brand data to facilitate the generation of the confidence scores.

In accordance with additional aspects of the technology described herein, the content generation system generates brand-aligned marketing content using structured brand data. In particular, the structured brand data is provided as input to a generative model, which generates brand-aligned marketing content based on the structured brand data. For instance, in some aspects, the structured brand data forms part of a prompt that is provided as input to the generative model, where the prompt provides information that instructs the generative model on the generation of the brand-aligned marketing content (e.g., type of marketing content to generate, an audience of the market content, etc.).

The content generation system also determines alignment scores for the brand-aligned marketing content. Each alignment score provides an indication of the extent to which the brand-aligned marketing content comports to a component of the brand source data. In this way, the content generation system provides a mechanism for verifying the brand-aligned marketing content provided by the generative model accurately captures the concepts and characteristics of the entity's brand as set forth in the structured brand data. In some aspects, the alignment score for a given component of the structured brand data is generated by comparing the brand-aligned marketing content against the component, for instance, using a Natural Language Inference (NLI) paradigm in which the brand-aligned marketing content is treated as a premise and the component of the structured brand data is treated as a hypothesis.

Aspects of the technology described herein provide a number of improvements over existing content generation approaches. For instance, the content generation system described herein enhances the identification and management of brand value, reduces manual errors, and strengthens brand recognition, facilitating consistent and effective application in the digital era.

In some aspects, the technology described herein harnesses the advanced language understanding capabilities of generative models (e.g., LLMs) to precisely interpret and convert unstructured brand data into a comprehensive and structured format. This approach enhances efficiency, reduces errors, and strengthens consistency in representing brand DNA. When brand-aligned marketing content is generated using the structured brand data, the brand-aligned marketing content is aligned with and reflective of the brand's unique identity. This structured brand data encapsulates crucial elements of the brand, such as its core values, distinct tone, preferred communication style, image guidelines, key messaging, and taglines, providing a comprehensive guideline for content creation.

By adhering to the structured guidelines set forth in the structured brand data during the content generation process, the system ensures a high level of consistency across all generated content. This ensures that irrespective of the quantity or variety of content produced, the brand's unique voice and identity are accurately represented and maintained, reducing the risk of dilution or misrepresentation.

The use of confidence and alignment scores provides an additional layer of validation. In particular, the scores not only improve the reliability of the generated structured brand data and brand-aligned marketing content but also enhances confidence in its adherence to intended aspects of the entity's brand.

The content generation system further alleviates the need for manual interpretation of brand guidelines, making the content generation process more efficient. It automates the process while ensuring that the content produced retains the brand's distinctive voice and aligns with its guidelines, thereby providing a solution that is both time-efficient and quality-oriented. This also reduces the need for reviewing and revising generated content, thereby addressing the issues of unnecessary computing resources utilization of conventional approaches described above.

### Example System for Generating Structured Brand Data and Brand-Aligned Marketing Content

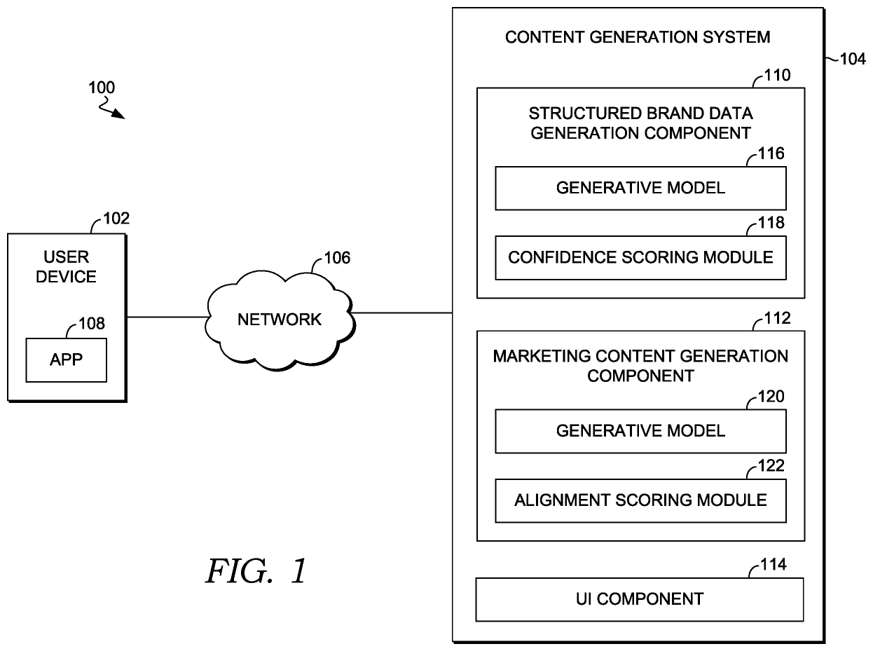

With reference now to the drawings, FIG. 1 is a block diagram illustrating an exemplary system 100 for generating structured brand data and using the structured brand data to generate brand-aligned marketing content in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

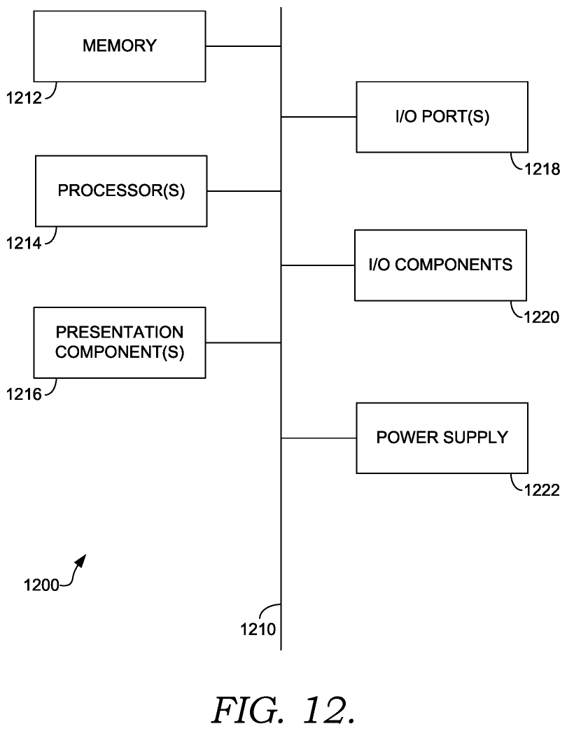

The system 100 is an example of a suitable architecture for implementing certain aspects of the present disclosure. Among other components not shown, the system 100 includes a user device 102 and a content generation system 104. Each of the user device 102 and content generation system 104 shown in FIG. 1 can comprise one or more computer devices, such as the computing device 1200 of FIG. 12, discussed below. As shown in FIG. 1, the user device 102 and the content generation system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of user devices and server devices can be employed within the system 100 within the scope of the present technology. Each can comprise a single device or multiple devices cooperating in a distributed environment. For instance, the content generation system 104 could be provided by multiple server devices collectively providing the functionality of the content generation system 104 as described herein. Additionally, other components not shown can also be included within the network environment.

The user device 102 can be a client device on the client-side of operating environment 100, while the content generation system 104 can be on the server-side of operating environment 100. The content generation system 104 can comprise server-side software designed to work in conjunction with client-side software on the user device 102 so as to implement any combination of the features and functionalities discussed in the present disclosure. For instance, the user device 102 can include an application 108 for interacting with the content generation system 104. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the content generation system 104 remain as separate entities. While the operating environment 100 illustrates a configuration in a networked environment with a separate user device 102 and content generation system 104, it should be understood that other configurations can be employed in which components are combined. For instance, in some configurations, the user device 102 can provide some or all of the capabilities of the content generation system 104 described herein.

The user device 102 comprises any type of computing device capable of use by a user. For example, in one aspect, the user device comprises the type of computing device 1200 described in relation to FIG. 12 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where notifications can be presented. A user can be associated with the user device 102 and can interact with the content generation system 104 via the user device 102.

As will be described in further detail below, the content generation system 104 employs one or more generative models to generate structured brand data and to also generate brand-aligned marketing content using the structured brand data. As shown in FIG. 1, the content generation system 104 includes a structured brand data generation component 110, a marketing content generation component 112, and a user interface (UI) component 114. The components of the content generation system 104 can be in addition to other components that provide further additional functions beyond the features described herein. The content generation system 104 can be implemented using one or more server devices, one or more platforms with corresponding application programming interfaces, cloud infrastructure, and the like. While the content generation system 104 is shown separate from the user device 102 in the configuration of FIG. 1, it should be understood that in other configurations, some or all of the functions of the content generation system 104 can be provided on the user device 102.

In one aspect, the functions performed by components of the content generation system 104 are associated with one or more applications, services, or routines. In particular, such applications, services, or routines can operate on one or more user devices, servers, can be distributed across one or more user devices and servers, or be implemented in the cloud. Moreover, in some aspects, these components of the content generation system 104 can be distributed across a network, including one or more servers and client devices, in the cloud, and/or can reside on a user device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The structured brand data generation component 110 of the content generation system 104 generates structured brand data and determines confidence scores for the various components of the structured brand data. As shown in FIG. 1, the structured brand data generation component 110 includes a generative model 116 and a confidence scoring module 118. Given brand source data for an entity, the generative model 116 generates text to provide structured brand data for the entity. The confidence scoring module 118 generates a confidence score for each component of the generated structured brand data to reflect an extent to which each component of the structured brand data comports to the brand source data for the entity.

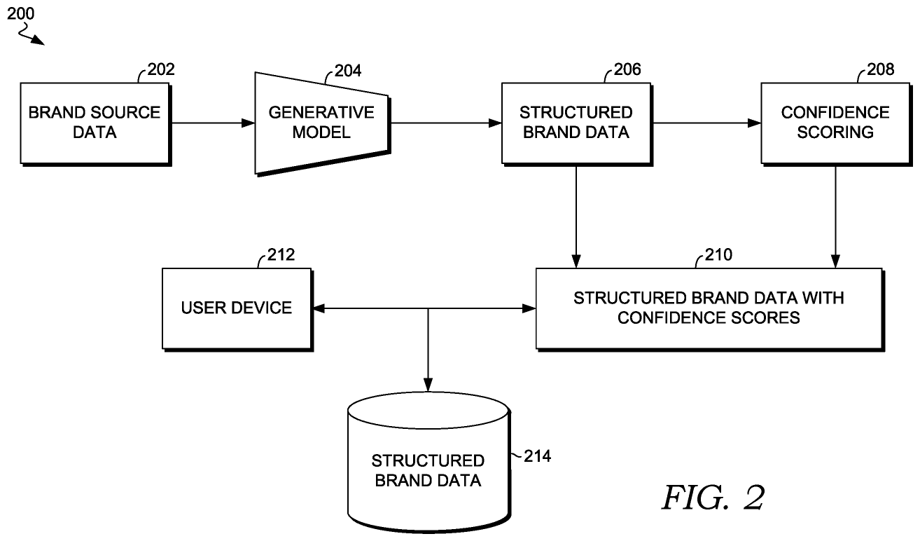

FIG. 2 provides a block diagram showing an example process 200 for generating structured brand data that can be performed, for instance, via the structured brand data generation component 110. As shown in FIG. 2, brand source data 202 is provided as input to a generative model 204. The brand source data 202 can comprise any information describing, exhibiting, or otherwise related to or evident of an entity's brand. The brand source data 202 can include materials, documents, and/or multimedia content that communicate information regarding the entity, such as its identity, values, and messaging. By way of example only and not limitation, the brand source data 202 can include the entity's website, social media profile, advertising/marketing materials, taglines, slogans, logos, mission statements, vision statements, product packaging, and brand guideline documents. In accordance with some aspects of the technology described herein, the brand source data 202 comprises unstructured data in the sense that the data does not conform to a particular schema. For instance, while some portions of the brand source data 202 may have some internal organization (e.g., organized into different sections), the brand source data 202 does not conform to a particular schema.

Using the brand source data 202 as an input, the generative model 204 (which can correspond to the generative model 116 of FIG. 1) generates structured brand data 206. The structured brand data 206 (e.g., “brand DNA”) comprises information describing the concepts and characteristics that define the entity's brand. In accordance with some aspects of the technology described herein, the structured brand data 206 is structured according to a particular schema having a number of components. In some aspects, the structured brand data 206 can be stored in a particular format, such as a JSON format. By way of example only and not limitation, in some aspects of the technology described herein, the schema includes the following components:

Tone of Voice: This section describes the brand's tone of voice, communication style, and preferred language. It is analyzed based on the brand's catalog content.

Brand Values and Attributes: This section analyzes the values and attributes that the brand represents, emphasizing the core values and unique characteristics that differentiate it from competitors.

Brand Image and Messaging: Drawing from the brand's catalog content, this section provides guidelines for brand image and messaging, highlighting key points to emphasize and elements to avoid.

Taglines: Potential and representative taglines for the brand are generated based on the brand's catalog content.

Forbidden Taglines: Identifying taglines used by competitors that the brand wishes to avoid. These are captured from the brand catalog to ensure awareness during the application of the brand tagline.

Brand Keywords: This section identifies key words and phrases that resonate with the brand, representative words, and frequently used keywords that should be incorporated into the brand's messaging to reinforce its brand DNA.

Forbidden Keywords: Identifying keywords or connotations that the brand wants to avoid and disassociate from.

Extra Information: This section provides an overall assessment of the brand based on its catalog, including its representation, target audience, and guidelines for effectively communicating its message.

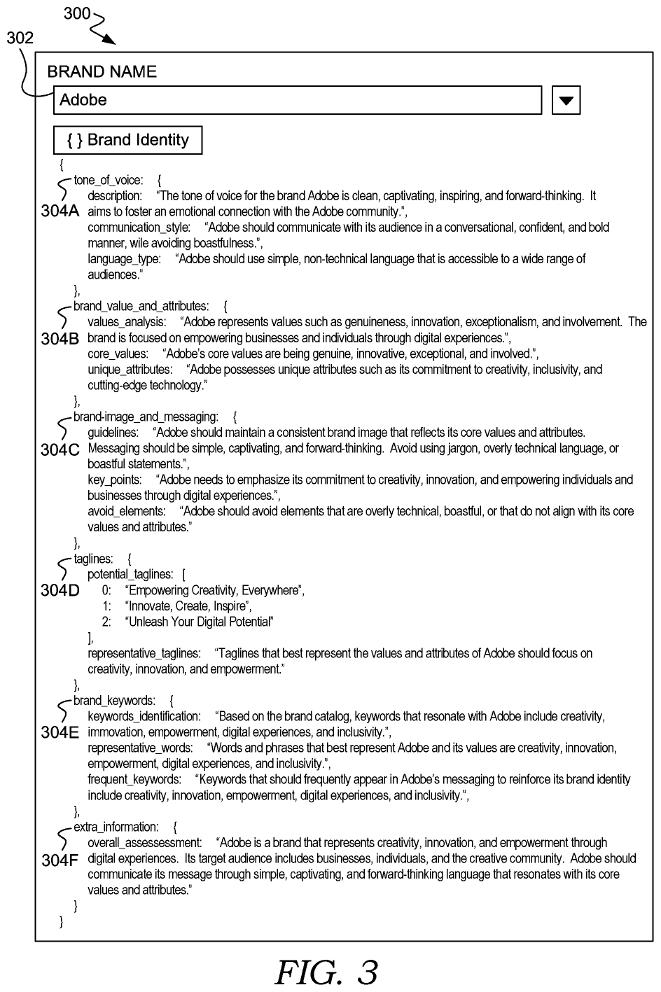

FIG. 3 provides an example of structured brand data 300 generated in accordance with some aspects of the technology described herein. As shown in FIG. 3, the structured brand data 300 has been generated for an identified brand 302. The structured brand data 300 includes a number of components, including a tone of voice component 304A, a brand value and attributes component 304B, a brand image and message component 304C, a taglines component 304D, a brand keywords component 304E, and an extra information component 304F. Each of the components 304A-304F identifies the component and includes generated text describing aspects of the component. FIG. 3 provides an example in which the structured brand data 300 is provided in a JSON format. However, it should be understood that other formats can be employed within the scope of embodiments of the present technology.

Returning to FIG. 2, the generative model 204 can comprise a language model that includes a set of statistical or probabilistic functions that performs Natural Language Processing (NLP) in order to understand, learn, and/or generate human natural language content. For example, a language model can be a tool that determines the probability of a given sequence of words occurring in a sentence (e.g., via NSP or MLM) or natural language sequence. Simply put, it can be a model that is trained to predict the next word in a sentence. A language model is called an LLM when it is trained on enormous amount of data. Some examples of LLMs are GOOGLE's BERT and OpenAI's GPT-2 and GPT-3. These models have capabilities ranging from writing a simple essay to generating complex computer codes-all with limited to no supervision. Accordingly, an LLM can comprise a deep neural network that is very large (billions to hundreds of billions of parameters) and understands, processes, and produces human natural language by being trained on massive amounts of text. These models can predict future words in a sentence letting them generate sentences similar to how humans talk and write.

In accordance with some aspects, the generative model 204 comprises a neural network. As used herein, a neural network comprises at least three operational layers, although a neural network may include many more than three layers (i.e., a deep neural network). The three layers can include an input layer, a hidden layer, and an output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

The generative model 204 can comprise a model that is built and trained from scratch, a pre-trained model (e.g., GPT-3), or a pre-trained model that has been fine-tuned. In some instances (e.g., using a pre-trained model), the input to the generative model 204 comprises a prompt with the brand source data 202 in which the prompt is configured to cause the generative model 204 to produce the structured brand data 206 to conform to a schema having particular components. For instance, the prompt could specify the components of the schema to instruct the generative model 204 to produce the structured brand data 206 such that it is structured to include those components.

In some aspects, the generative model 204 is trained or fine-tuned using training data. For instance, the training data can comprise pairs of brand source data and predefined structured brand data (e.g., manually generated structured brand data), and the generative model 204 is trained to fit the training data. During training, weights associated with each neuron can be updated. Originally, the generative model 204 can comprise random weight values or pre-trained weight values that are adjusted during training. In one aspect, the generative model 204 is trained using backpropagation. The backpropagation process comprises a forward pass, a loss function, a backward pass, and a weight update. This process is repeated using the training data. For instance, each iteration could include providing brand source data as input to the model, generating an output by the model, comparing (e.g., computing a loss) the model output and the predefined structured brand data paired with the input brand source data, and updating the model based on the comparison. The goal is to update the weights of each neuron (or other model component) to cause the generative model to produce structured brand data that comports to a schema with particular components. Once trained, the weight associated with a given neuron can remain fixed. The other data passing between neurons can change in response to a given input. Retraining the network with additional training data can update one or more weights in one or more neurons.

After generating the structured brand data 206, confidence scoring 208 is performed (e.g., via the confidence scoring module 118 of FIG. 1) for the structured brand data 206. Generally, the confidence scoring 208 comprises generating a confidence score for each component of the structured brand data 206 that reflects the extent to which the component comports to a relevant portion of the brand source data 202. The confidence scoring 208 can further include determining an overall confidence score for the structured brand data 206 that reflects the extent to which the structured brand data 206 as a whole comports to the brand source data 202. In some aspects, the overall confidence score for the structured brand data 206 is a function of the confidence scores for the components of the structured brand data 206 (e.g., an average of the component confidence scores).

In accordance with some aspects, the confidence scoring 208 for structured brand data components comprises identifying portions of the brand source data 202 corresponding with the structured brand data components. The confidence scoring 208 then generates a confidence score for a given structured brand data component using the portion(s) of the brand source data 202 relevant to that structured brand data component. For instance, if the structured brand data 206 includes a component for tone of voice, the confidence scoring 208 determines a portion of the structured brand data 206 that is relevant to tone of voice and uses that portion to determine the confidence score for the tone of voice component.

In some configurations, one or more relevant portions of the brand source data 202 are determined for each component of the structured brand data 206 using a latent vector space of a model (e.g., a machine learning model, such as a neural network). A latent vector space (or embedding space) is a mathematical representation where items are transformed by a model into numerical vectors. A vector representation of an item in a latent vector space of a model is referred to herein as an embedding. In accordance with some aspects, the brand source data 202 is divided into separate portions, and an embedding is generated for each portion (e.g., by providing each portion as input to the model providing the latent vector space). Additionally, an embedding is generated for each component of the structured brand data 206 (e.g., by providing each component as input to the model providing the latent vector space). One or more portions of the brand source data 202 relevant to a particular component of the structured brand data 206 are determined based on the similarity (e.g., proximity) of the embeddings for the portions of the brand source data 202 to the embedding for the component of the structured brand data 206 in the latent vector space. The similarity of embeddings in the latent vector space can be determined, for instance, using a cosine similarity or similar function.

After identifying one or more portions of the brand source data 202 that are relevant to a given component of the structured brand data 206, a confidence score for the component of the structured brand data 206 is based on a comparison of the identified portion(s) of the brand source data 202 and the component of the structured brand data 206. In some aspects, the comparison is performed using a Natural Language Inference (NLI) paradigm (although other approaches can be employed in other aspects). NLI, also known as textual entailment, is a natural language processing (NLP) task that involves determining the logical relationship between two given text segments: a “premise” and a “hypothesis.” The goal of NLI is to determine whether the hypothesis can be logically inferred (entailed) from the premise, or if it contradicts it (contradiction), or if there is no clear logical relationship (neutral). In accordance with some configurations, a confidence score for a component of the structured brand data 206 is determined using NLI by treating the identified portion(s) of the brand source data 202 as the premise and the component of the structured brand data 206.

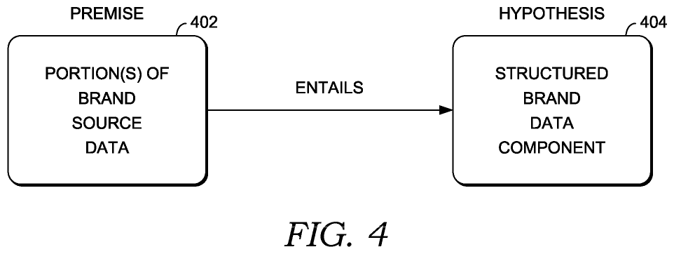

FIG. 4 is a block diagram illustrating the use of NLI to evaluate a component of structured brand data. As shown in FIG. 4, one or more portions of brand source content that have been determined to be relevant to a structured brand data component are treated as a premise 402. Additionally, the structured brand data component being evaluated is treated as a hypothesis 404. Textual entailment between the premise 402 and the hypothesis 404 is determined by evaluating whether the information presented in the hypothesis 404 can logically follow from, or be inferred from, the information provided in the premise 402. In some configurations, this assessment is performed using an NLI model (e.g., machine learning model, such as a neural network) that analyzes the semantic content and context of the premise 402 and hypothesis 404 to make informed judgments about their logical compatibility. For instance, an NLI model could be employed that has been trained on labeled datasets to classify the relationship between text pairs into categories like “entailment,” “contradiction,” or “neutral.” In some embodiments, the NLI model outputs a numerical score indicative of entailment. The textual or numerical output of the NLI model can be provided as the confidence score for the component of the structured brand data.

With reference again to FIG. 2, the structured brand data with confidence scores 210 are provided to a user device 212 for presentation and/or stored in a structured brand datastore 214. By presenting the structured brand data and confidence scores on the user device 212, an administrator or other user associated with the entity whose brand is being managed can confirm whether the various components of the structured brand data 206 comport with relevant portions of the brand source data 202. For instance, a user could review the confidence scores associated with each component of structured brand data 206. If a confidence score for a given component is below some threshold, the user can manually edit the component or have the generative model 204 regenerate the component. In some aspects, the system automatically regenerates any component of the structured brand data for which the confidence score is below a threshold. This could include repeatedly generating the component using the generative model 204, determining a confidence score for the component, and comparing the confidence score to a threshold until a component is generated whose confidence score satisfies the threshold.

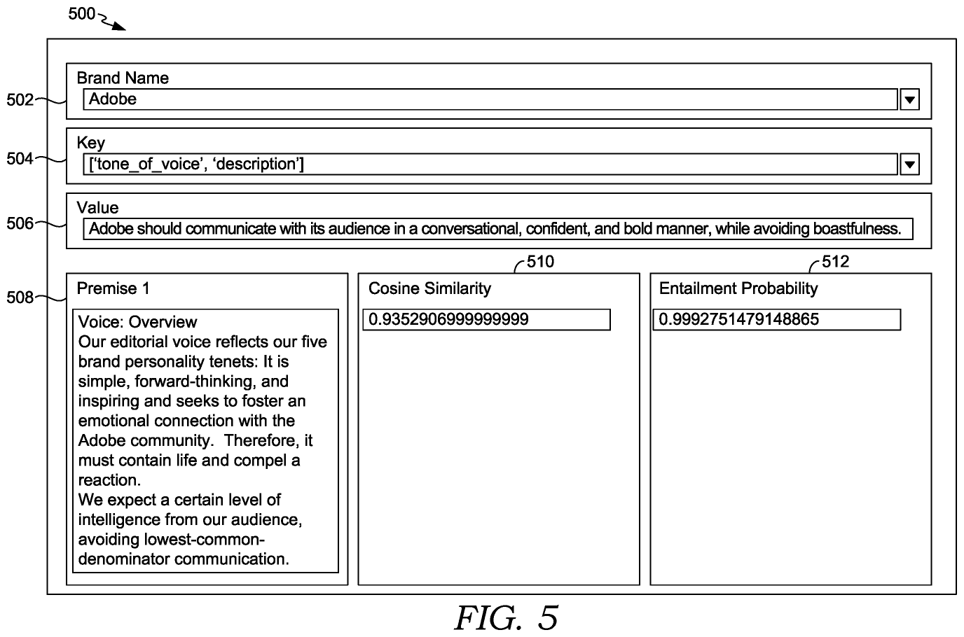

FIG. 5 provides an example user interface 500 presenting a component of structured brand data generated using a generative model and its associated confidence score. The user interface 500 identifies the brand 502 being managed and the title 504 of the structured brand data component. The user interface 500 also provides the generated text 506 for the structured brand data component, as well as portions 508 of the brand source data determined to be relevant to this structured brand data component. The user interface 500 further provides a cosine similarity score 510 that reflects a similarity determined between the structured brand data component and the relevant portions of the brand source data. The user interface further includes an entailment probability 512 determined via NLI using the relevant portions of the brand source data as the premise and the component of the structured brand data as the hypothesis. The entailment probability 512 reflects a probability that the hypothesis can be logically inferred (entailed) from the premise. In this example, the entailment probability 512 is provided as the confidence score for the structured brand data component. Similar user interfaces could be provided for each structured brand data component to provide an indication of the confidence score for each component. In some further aspects, a user interface provides an overall confidence score for the structured brand data as a whole. The overall confidence score for the structured brand data can be computed as a function (e.g., average) of the confidence scores for the individual components of the structured brand data.

With reference again to FIG. 1, the content generation system 104 also includes a marketing content generation component 112 that generates brand-aligned marketing content and determines alignment scores for the brand-aligned marketing content. As shown in FIG. 1, the marketing content generation component 112 includes a generative model 120 (which could be the same model as the generative model 116 or a different model) and an alignment scoring module 122. Using structured brand data for an entity (e.g., generated by the structured brand data generation component 110), the generative model 120 generates text to provide brand-aligned marketing content for the entity. The alignment scoring module 122 generates alignment scores for the brand-aligned marketing content that reflect the extent to which the marking content comports to each component of the structured brand data.

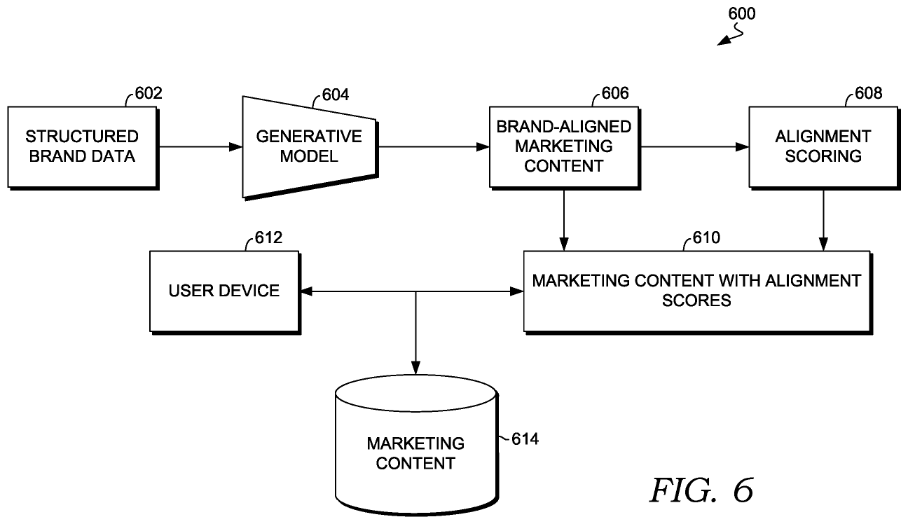

FIG. 6 provides a block diagram showing an example process 600 for generating brand-aligned marketing content that can be performed, for instance, via the marketing content generation component 112. As shown in FIG. 6, structured brand data 602 is provided as input to a generative model 604. The structured brand data 602 could comprise the structured brand data 206 generated in accordance with the process 200 discussed above with reference to FIG. 2. The structured brand data 602 comprises information describing the concepts and characteristics that define the entity's brand. The structured brand data 602 is structured according to a particular schema having a number of components. In some aspects, the structured brand data 602 is used as part of a prompt that is provided as input to the generative model 604. The prompt could include, for instance, information or instructions about a type of marketing content to generate (e.g., email, blog, social media post etc.), an audience of the market content, as well as other information/instructions useful to instruct the generative model 604 regarding the generation of the marketing content.

Using the structured brand data 602 as an input, the generative model 604 (which can correspond to the generative model 120 of FIG. 1) generates brand-aligned marketing content 606. The brand-aligned marketing content 606 comprises any type of material or information used by the entity to promote its products, services, brand, and/or ideas to its target audience. By way of example only and not limitation, the brand-aligned marketing content 606 generated by the generative model 604 can comprise a blog post, a social media post, an email marketing message, webpage content, a press release, an advertisement, interactive content, an infographic, or a whitepaper.

The generative model 604 can comprise a language model that includes a set of statistical or probabilistic functions that performs Natural Language Processing (NLP) in order to understand, learn, and/or generate human natural language content. For example, a language model can be a tool that determines the probability of a given sequence of words occurring in a sentence (e.g., via NSP or MLM) or natural language sequence. Simply put, it can be a model that is trained to predict the next word in a sentence. A language model is called an LLM when it is trained on enormous amount of data. Some examples of LLMs are GOOGLE's BERT and OpenAI's GPT-2 and GPT-3. These models have capabilities ranging from writing a simple essay to generating complex computer codes-all with limited to no supervision. Accordingly, an LLM can comprise a deep neural network that is very large (billions to hundreds of billions of parameters) and understands, processes, and produces human natural language by being trained on massive amounts of text. These models can predict future words in a sentence letting them generate sentences similar to how humans talk and write.

In accordance with some aspects, the generative model 604 comprises a neural network. As used herein, a neural network comprises at least three operational layers, although a neural network may include many more than three layers (i.e., a deep neural network). The three layers can include an input layer, a hidden layer, and an output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

The generative model 604 can comprise a model that is built and trained from scratch, a pre-trained model (e.g., GPT-3), or a pre-trained model that has been fine-tuned. In some instances (e.g., using a pre-trained model), the input to the generative model 604 comprises a prompt with the structured brand data in which the prompt is configured to cause the generative model 604 to produce brand-aligned marketing content 606 of a particular type. For instance, the prompt could instruct the generative model 604 to produce a marketing email that complies with the structured brand data 602.

In some aspects, the generative model 604 is trained or fine-tuned using training data. For instance, the training data can comprise pairs of structured brand data (which could comprise structured brand data 602 and/or other structured brand data) and particular type(s) of predefined marketing content (e.g., manually-generated marketing content), and the generative model 604 is trained to fit the training data. During training, weights associated with each neuron can be updated. Originally, the generative model 604 can comprise random weight values or pre-trained weight values that are adjusted during training. In one aspect, the generative model 604 is trained using backpropagation. The backpropagation process comprises a forward pass, a loss function, a backward pass, and a weight update. This process is repeated using the training data. For instance, each iteration could include providing structured brand data as input to the model, generating an output by the model, comparing (e.g., computing a loss) the model output and the predefined marketing content paired with the input brand source data, and updating the model based on the comparison. The goal is to update the weights of each neuron (or other model component) to cause the generative model to produce brand-aligned marketing content that comports with the structured brand data. Once trained, the weight associated with a given neuron can remain fixed. The other data passing between neurons can change in response to a given input. Retraining the network with additional training data can update one or more weights in one or more neurons.

After generating the brand-aligned marketing content 606, alignment scoring 608 is performed (e.g., via the alignment scoring module 122 of FIG. 1) for the brand-aligned marketing content 606. Generally, the alignment scoring 608 comprises generating an alignment score for each component of the structured brand data 602 that reflects the extent to which the brand-aligned marketing content 606 comports to each component of the structured brand data 602. The alignment scoring 608 can further include determining an overall alignment score for the brand-aligned marketing content 606 that reflects the extent to which the brand-aligned marketing content 606 comports to the structured brand data 602 as a whole. In some aspects, the overall alignment score for the brand-aligned marketing content 606 is a function of the alignment scores for the components of the structured brand data 602 (e.g., an average of the component alignment scores).

The alignment score for each component of the structured brand data 602 is based on a comparison of the brand-aligned marketing content 606 and the component of the structured brand data 602. In some aspects, the comparison is performed using an NLI paradigm (although other approaches can be employed in other aspects). NLI, also known as textual entailment, is a natural language processing (NLP) task that involves determining the logical relationship between two given text segments: a “premise” and a “hypothesis.” The goal of NLI is to determine whether the hypothesis can be logically inferred (entailed) from the premise, or if it contradicts it, or if there is no clear logical relationship (neutral). In accordance with some configurations, an alignment score corresponding to a component of the structured brand data 602 is determined using NLI by treating the brand-aligned marketing content 606 as the premise and the component of the structured brand data 602 as the hypothesis.

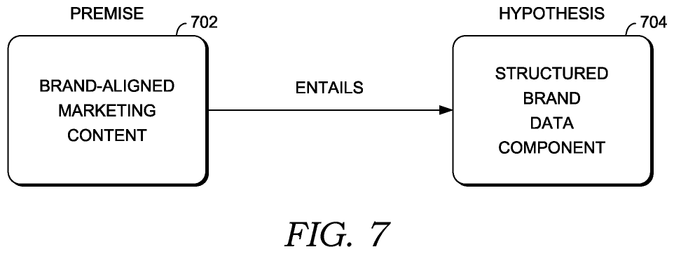

FIG. 7 is a block diagram illustrating the use of NLI to evaluate brand-aligned marketing content with respect to a component of structured brand data. As shown in FIG. 7, the generated brand-aligned marketing content is treated as a premise 702. Additionally, the structured brand data component being evaluated is treated as a hypothesis 704. Textual entailment between the premise 702 and the hypothesis 704 is determined by evaluating whether the information presented in the hypothesis 704 can logically follow from, or be inferred from, the information provided in the premise 702. In some configurations, this assessment is performed using an NLI model (e.g., a machine learning model, such as a neural network) that analyzes the semantic content and context of the premise 702 and hypothesis 704 to make informed judgments about their logical compatibility. For instance, an NLI model could be employed that has been trained on labeled datasets to classify the relationship between text pairs into categories like “entailment,” “contradiction,” or “neutral.” In some embodiments, the NLI model outputs a numerical score indicative of entailment. The textual or numerical output can be provided as the alignment score for the component of the structured brand data.

With reference again to FIG. 6, the brand-aligned marketing content with alignment scores 610 are provided to a user device 612 for presentation and/or stored in a structured brand datastore 614. By presenting the brand-aligned marketing content and alignment scores on the user device 612, an administrator or other user associated with the entity whose brand is being managed can confirm whether the brand-aligned marketing content 606 comports with the various components of the structured brand data 602. For instance, a user could review the alignment scores associated with each component of structured brand data 602. If an alignment score for a given component is below some threshold, the user can manually edit the brand-aligned marketing content or have the generative model 604 regenerate the brand-aligned marketing content (or portions thereof). In some aspects, the system automatically regenerates the brand-aligned marketing content 606 (or portions thereof) based on the alignment score for any component of the structured brand data 602 being below a threshold. This could include repeatedly generating the brand-aligned marketing content 606 using the generative model 604, determining an alignment score for each component of the structured brand data 602, and comparing each alignment score to a threshold until each alignment score satisfies the threshold.

Turning again to FIG. 1, the content generation system 104 further includes a user interface component 114 that provides one or more user interfaces for interacting with the content generation system 104. The user interface component 114 provides one or more user interfaces to a user device, such as the user device 102. In some instances, the user interfaces can be presented on the user device 102 via the application 108, which can be a web browser or a dedicated application for interacting with the content generation system 104. For instance, the user interface component 114 can provide user interfaces for, among other things, interacting with the content generation system 104 to submit brand source data and/or other input for generating structured brand data. The user interface component 114 can also provide user interfaces for presenting various components of the structure brand data and associated confidence scores. The user interface component 114 can further provide user interfaces for submitting structured brand data and/or other input for generating brand-aligned marketing content. The user interface component can still further provide user interfaces for presenting alignment scores for generated brand-aligned marketing content with respect to various components of structured brand data used to generate the brand-aligned marketing content.

### Example Methods for Generating Structured Brand Data and Brand-Aligned Marketing Content

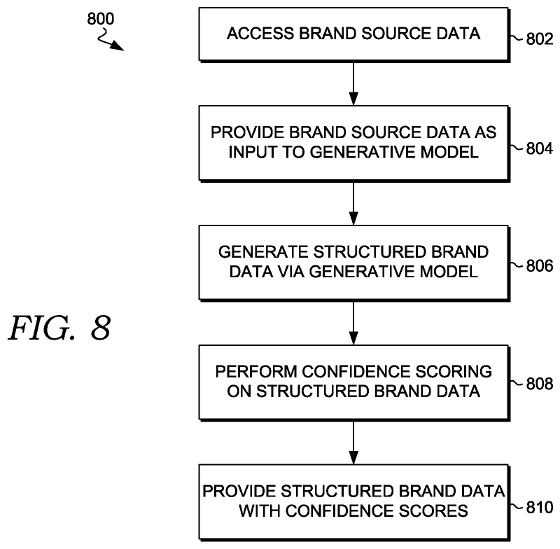

With reference now to FIG. 8, a flow diagram is provided that illustrates a method 800 for generating structured brand data from brand source data. The method 800 can be performed, for instance, by the structured brand data generation component 110 of FIG. 1. Each block of the method 800 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 802, brand source data is accessed. The brand source data is provided as input to a generative model, as shown at block 804. This can include generating a prompt based on the brand source data. In some aspects, the prompt is configured to instruct the generative model to generate structured brand data having a particular schema. This could include configuring the prompt to specify the components for the structured brand data. The generative model generates structured brand data based on the brand source data, as shown at block 806. The generative model generates the structured brand data by generating text for each of the components of the schema for the structured brand data.

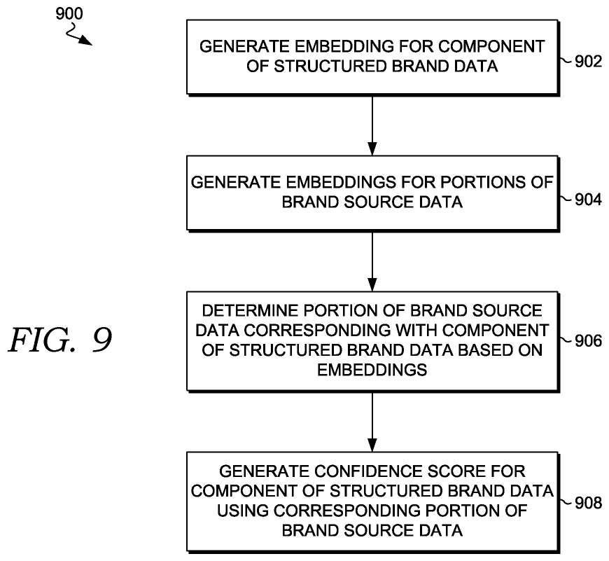

Confidence scoring for the structured brand data is performed, as shown at block 808. The confidence scoring includes determining a confidence score for each component of the structured brand data that reflects whether each component comports to the brand source data. The confidence score for a given component of the structured brand data can be determined, for instance, using the method 900 discussed below with reference to FIG. 9 (although other confidence scoring approaches could be used in some configurations). In some aspects, the confidence scoring also includes determining an overall confidence score for the structured brand data. The overall confidence score can be determined as a function (e.g., average) of the confidence scores for the individual components of the structured brand data.

The structured brand data and confidence scores are provided for presentation, as shown at block 810. This allows a user to review the structured brand data and the confidence scores to determine whether any changes should be made to the structured brand data or if the structured brand data otherwise adequately captures the concepts and characteristics of the entity's brand.

FIG. 9 is a flow diagram showing a method 900 for generating a confidence score for a structured brand data component. The method 900 can be performed for instance, by the confidence scoring module 118 of FIG. 1. As shown at block 902, an embedding is generated for a component of the structured brand data. The embedding for the structured brand data component comprises a numerical representation of the component in a latent vector space of a model (e.g., a machine learning model, such as a neural network) used to generate the embedding. Embeddings are also generated for portions of the brand source data, as shown at block 904. For instance, the brand source data can be divided into a number of portions, and an embedding is generated for each portion. The embedding for a portion of the brand source data comprises a numerical representation of the portion in the latent vector space of the model.

One or more potions of the brand source data are determined as corresponding to the component of the structured brand data based on the embeddings, as shown at block 906. Generally, a similarity can be determined (e.g., cosine similarity) between the embedding for the component of the structured brand data and the embedding for each portion of the brand source data, and one or more portions with embeddings having the closest similarity to the embedding for the component of the structured brand data can be selected.

As shown at block 908, a confidence score for the component of the structured brand data is generated using the corresponding portion(s) of the brand source data identified at block 906. The confidence score is determined by comparing the component of the structured brand data with the identified portion(s) of the brand source data. In some aspects, the comparison is performed using an NLI model that treats the portion(s) of the brand source data as the premise and the component of the structured brand data as the hypothesis. The output of the NLI model can be used as the confidence score for the component of the structured brand data. The process 900 could be performed for each component of the structured brand data to provide a confidence score for each component indicative of whether each component comports to the brand source data.

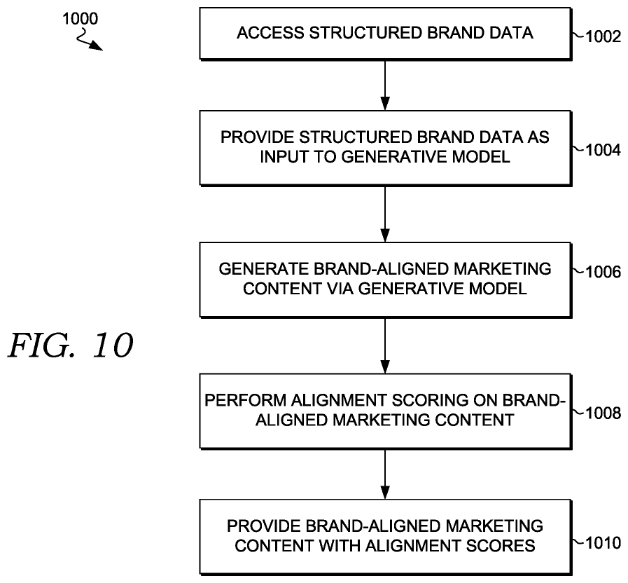

With reference next to FIG. 10, a flow diagram is provided illustrating a method 1000 for generating brand-aligned marketing content using structured brand data. The method 1000 can be performed, for instance, by the marketing content generation component 112 of FIG. 1. As shown at block 1002, structured brand data is accessed. The structured brand data comprises text organized into a number of components based on a schema. The structured brand is provided as input to a generative model, as shown at block 1004. This can include generating a prompt based on the structured brand data. In some aspects, the prompt is configured to instruct the generative model to generate brand-aligned marketing content of a particular type (e.g., email message, blog, social media post, etc.), provide information on a target audience, and/or provide other information or instructions directing the generative model on how to generate the brand-aligned marketing content. The generative model generates brand-aligned marketing content based on the structured brand data, as shown at block 1006. The generative model generates the brand-aligned marketing content by generating text for the brand-aligned marketing content using the structured brand data.

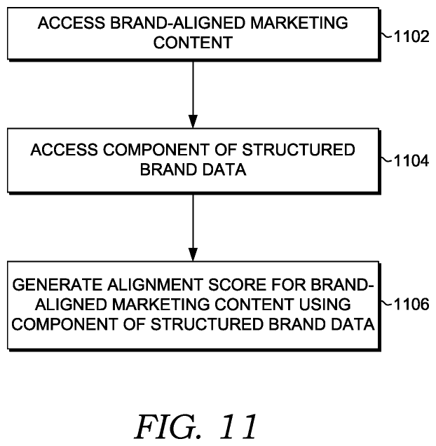

Alignment scoring for the brand-aligned marketing content is performed, as shown at block 1008. The alignment scoring for the brand-aligned marketing content includes determining an alignment score for each component of the structured brand data that reflects whether the brand-aligned marketing content comports to each component. The alignment score for a given component of the structured brand data can be determined, for instance, using the method 1100 discussed below with reference to FIG. 11 (although other alignment scoring approaches could be used in some configurations). In some aspects, the alignment scoring also includes determining an overall confidence score for the brand-aligned marketing content. The overall alignment score for the brand-aligned marketing content can be determined as a function (e.g., average) of the alignment scores for the individual components of the structured brand data.

The brand-aligned marketing content and alignment scores are provided for presentation, as shown at block 1010. This allows a user to review the brand-aligned marketing content and the alignment scores to determine whether any changes should be made to the brand-aligned marketing content or if the brand-aligned marketing content otherwise adequately aligns with the entity's brand as set forth by the structured brand data.

FIG. 11 is a flow diagram showing a method 1100 for generating an alignment score for brand-aligned marketing content with respect to a structured brand data component. The method 1100 can be performed, for instance, by the alignment scoring module 122 of FIG. 1. As shown at block 1102, brand-aligned marketing content is accessed. The brand-aligned marketing content could be generated using structured brand content, for instance, via the method 1000 discussed above with reference to FIG. 10. A component of the structured brand content is also accessed, as shown at block 1104.

As shown at block 1106, an alignment score for brand-aligned marketing content with respect to the component of the structured brand data is generated. The alignment score is determined by comparing the brand-aligned marketing content with the component of the structured brand data. In some aspects, the comparison is performed using an NLI model that treats the brand-aligned marketing content as the premise and the component of the structured brand data as the hypothesis. The output of the NLI model can be used as the alignment score for the brand-aligned marketing content with respect to the component of the structured brand data. The process 1100 could be performed for each component of the structured brand data to provide an alignment score indicative of whether the brand-aligned marketing content aligns with each component of the structured brand data.

### Exemplary Operating Environment

Having described implementations of the present disclosure, an exemplary operating environment in which embodiments of the present technology can be implemented is described below in order to provide a general context for various aspects of the present disclosure. Referring initially to FIG. 12 in particular, an exemplary operating environment for implementing embodiments of the present technology is shown and designated generally as computing device 1200. Computing device 1200 is but one example of a suitable computing environment and is not intended to suggest any limitation as to the scope of use or functionality of the technology. Neither should the computing device 1200 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 12, computing device 1200 includes bus 1210 that directly or indirectly couples the following devices: memory 1212, one or more processors 1214, one or more presentation components 1216, input/output (I/O) ports 1218, input/output components 1220, and illustrative power supply 1222. Bus 1210 represents what can be one or more busses (such as an address bus, data bus, or combination thereof). Although the various blocks of FIG. 12 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 12 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 12 and reference to “computing device.”

Computing device 1200 typically includes a variety of computer-readable media. Computer-readable media can be any available media that can be accessed by computing device 1200 and includes both volatile and nonvolatile media, removable and non-removable media. By way of example, and not limitation, computer-readable media can comprise computer storage media and communication media.

Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1200. Computer storage media does not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1212 includes computer storage media in the form of volatile and/or nonvolatile memory. The memory can be removable, non-removable, or a combination thereof. Exemplary hardware devices include solid-state memory, hard drives, optical-disc drives, etc. Computing device 1200 includes one or more processors that read data from various entities such as memory 1212 or I/O components 1220. Presentation component(s) 1216 present data indications to a user or other device. Exemplary presentation components include a display device, speaker, printing component, vibrating component, etc.

I/O ports 1218 allow computing device 1200 to be logically coupled to other devices including I/O components 1220, some of which can be built in. Illustrative components include a microphone, joystick, game pad, satellite dish, scanner, printer, wireless device, etc. The I/O components 1220 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 1200. The computing device 1200 can be equipped with depth cameras, such as, stereoscopic camera systems, infrared camera systems, RGB camera systems, and combinations of these for gesture detection and recognition. Additionally, the computing device 1200 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

1. One or more computer storage media storing computer-useable instructions that, when used by a computing device, cause the computing device to perform operations, the operations comprising:
accessing brand source data for an entity;
causing a first generative model to generate structured brand data using the brand source data, the structured brand data having a plurality of components in a predefined schema, the first generative model having been trained on training data comprising pairs of brand source data and predefined structured brand data in the predefined schema;
causing a second generative model to generate brand-aligned marketing content using the structured brand data, the second generative model having been trained on training data comprising pairs of structured brand data and marketing content;
determining a plurality of alignment scores for the brand-aligned marketing content, each alignment score of the plurality of alignment scores corresponding to a component of the plurality of components of the structured brand data; and
providing for presentation the brand-aligned marketing content and at least a portion of the plurality of alignment scores.

2. The one or more computer storage media of claim 1, wherein causing the first generative model to generate the structured brand data comprises:
generating a prompt using the brand source data, the prompt instructing the first generative model to generate the structured brand data; and
providing the prompt as input to the first generative model.

3. The one or more computer storage media of claim 1, wherein the prompt specifies the plurality of components of the structured brand data.

4. The one or more computer storage media of claim 1, wherein causing the second generative model to generate the brand-aligned marketing content comprises:
generating a prompt using the structured brand data, the prompt instructing the second generative model to generate the brand-aligned marketing content; and
providing the prompt as input to the second generative model.

5. The one or more computer storage media of claim 1, wherein determining a first alignment score of the plurality of alignment scores corresponding to a first component of the plurality of components of the structured brand data comprises:
causing a natural language inference model to generate the first alignment score by treating the brand-aligned marketing content as a premise and the first component of the structured brand data as a hypothesis.

6. The one or more computer storage media of claim 1, wherein the operations further comprise:
determining a plurality of confidence scores for the structured brand data, each confidence score of the plurality of confidence scores corresponding to a component of the plurality of components of the structured brand data; and
providing for presentation the structured brand data and at least a portion of the plurality of confidence scores.

7. The one or more computer storage media of claim 6, wherein determining a first confidence score of the plurality of confidence scores for a first component of the plurality of components of the structured brand data comprises:
identifying a portion of the brand source data as corresponding to the first component of the structured brand data; and
causing a natural language inference model to generate the first confidence score by treating the portion of the brand source data as a premise and the first component of the structured brand data as a hypothesis.

8. The one or more computer storage media of claim 7, wherein identifying the portion of the brand source data as corresponding to the first component of the structure brand data comprises:
employing a model to generate a first embedding for the first component of the structured brand data;
employing the model to generate a second embedding for the portion of the brand source data; and
determining a similarity between the first embedding and the second embedding.

9. A computer-implemented method comprising:
generating, by a first generative model, brand-aligned marketing content, the first generative model generating the brand-aligned marketing content using structured brand data having a plurality of components from a predefined schema, the first generative model having been trained on training data comprising pairs of structured brand data and marketing content;
determining, by an alignment scoring module, a plurality of alignment scores for the brand-aligned marketing content, each alignment score corresponding to a component of the plurality of components of the structured brand data; and
causing, by a user interface component, presentation of the brand-aligned marketing content and at least a portion of the plurality of alignment scores.

10. The computer-implemented method of claim 9, wherein the method further comprises:
generating a prompt using the structured brand data, the prompt instructing the first generative model to generate the brand-aligned marketing content; and
providing the prompt as input to the first generative model.

11. The computer-implemented method of claim 9, wherein determining a first alignment score of the plurality of alignment scores corresponding to a first component of the plurality of components of the structured brand data comprises:
causing a natural language inference model to generate the first alignment score by treating the brand-aligned marketing content as a premise and the first component of the structured brand data as a hypothesis.

12. The computer-implemented method of claim 9, wherein the method further comprises:
generating, by a second generative model, the structured brand data by providing brand source data as input to the second generative model, the second generative model having been trained on training data comprising pairs of brand source data and predefined structured brand data in the predefined schema.

13. The computer-implemented method of claim 12, wherein the method further comprises:
generating a prompt using the brand source data, the prompt instructing the second generative model to generate the structured brand data; and
providing the prompt as input to the second generative model.

14. The computer-implemented method of claim 13, wherein the prompt specifies the plurality of components of the structured brand data.

15. The computer-implemented method of claim 12, wherein the operations further comprise:
determining a plurality of confidence scores for the structured brand data, each confidence score of the plurality of confidence scores corresponding to a component of the plurality of components of the structured brand data; and
providing for presentation the structured brand data and at least a portion of the plurality of confidence scores.

16. The computer-implemented method of claim 15, wherein determining a first confidence score of the plurality of confidence scores for a first component of the plurality of components of the structured brand data comprises:
identifying a portion of the brand source data as corresponding to the first component of the structured brand data; and
causing a natural language inference model to generate the first confidence score by treating the portion of the brand source data as a premise and the first component of the structured brand data as a hypothesis.

17. The computer-implemented method of claim 16, wherein identifying the portion of the brand source data as corresponding to the first component of the structure brand data comprises:
employing a model to generate a first embedding for the first component of the structured brand data;
employing the model to generate a second embedding for the portion of the brand source data; and
determining a similarity between the first embedding and the second embedding.

18. A computer system comprising:
one or more processors; and
one or more computer storage media storing computer-useable instructions that, when used by the one or more processors, causes the one or more processors to perform operations comprising:
generating, by a first generative model, structured brand data having a plurality of components, the first generative model generating the structured brand data using brand source data;
determining, by a confidence scoring module, a plurality of confidence scores for the structured brand data, each confidence score of the plurality of confidence scores corresponding to a component of the plurality of components of the structured brand data; and
causing, by a user interface component, presentation of the structured brand data and at least a portion of the plurality of confidence scores.

19. The computer system of claim 18, wherein determining a first confidence score of the plurality of confidence scores for a first component of the plurality of components of the structured brand data comprises:
identifying a portion of the brand source data as corresponding to the first component of the structured brand data; and
causing a natural language inference model to generate the first confidence score by treating the portion of the brand source data as a premise and the first component of the structured brand data as a hypothesis.

20. The computer system of claim 19, wherein identifying the portion of the brand source data as corresponding to the first component of the structure brand data comprises:
employing a model to generate a first embedding for the first component of the structured brand data;
employing the model to generate a second embedding for the portion of the brand source data; and
determining a similarity between the first embedding and the second embedding.
